(19) United States
(12) Patent Application Publication
(10) Pub. No.: US 2026/0220506 A1
(43) Pub. Date: Jul. 30, 2026

(54) SYSTEMS AND METHODS FOR GENERATIVE REINFORCEMENT LEARNING FOR AUTOMATED KNOWLEDGE ACQUISITION AND PLANNING

(71) Applicants: William VEGA-BROWN, Salt Lake City, UT (US); Jonathan Garrity, New York, NY (US)

(72) Inventors: William VEGA-BROWN, Salt Lake City, UT (US); Jonathan Garrity, New York, NY (US)

(21) Appl. No.: 19/465,771

(22) Filed: Jan. 30, 2026

Related U.S. Application Data
(60) Provisional application No. 63/751,736, filed on Jan. 30, 2025.

(51) Int. Cl. G06N 5/046

(52) U.S. Cl. CPC G06N 5/046

(57) ABSTRACT

Systems and methods are provided to generate a predictive engine for a corresponding real-world domain based on Bayesian inferences applied to priors taken from large language model outputs and domain-expert knowledge, and to perform evaluation and reinforcement learning of counterfactual scenarios applied to the predictive engine. The approach accommodates offline/batch and online/real-time updates, leveraging cost functions and constraints to identify near-optimal actions without risky trial-and-error in the physical domain.

### TECHNICAL FIELD

The subject matter of this disclosure generally relates to establishing and updating a predictive engine capable of integrating domain-expert knowledge and outputs of large language models, and utilizing the resulting predictive engine to determine courses of action in complex and data-scarce domains. More specifically, this disclosure describes systems and methods that leverage approximate Bayesian inference, generative modeling, and reinforcement learning to make automated planning decisions in a wide range of real-world environments—including offline/batch contexts and online/real-time contexts—where direct experimentation is expensive or infeasible.

### BACKGROUND

Predictive engines may be used to perform automated planning or to optimize other automated tasks. For instance, in 1997, researchers developed a machine engine that defeated world champion Garry Kasparov in chess. Over the next two decades, further breakthroughs in backgammon, draughts, Go, and poker demonstrated that machine learning techniques could exceed human performance in well-defined game domains. However, these systems typically relied on either large amounts of domain-specific engineering or on training data generated by simulated or playing the game environment many times based on the defined rules and desired outcomes.

A core challenge for new real-world problem domains include building a sufficiently accurate model from limited data. When training data is scarce—e.g., in industrial logistics, medical decision-making, or large-scale scheduling—purely data-driven methods risk “hallucinating” or converging on poor policies because real-world experimentation is too expensive or dangerous to provide adequate feedback.

The main factor limiting the impact of automated planning is the challenge of accurately forecasting the effects of decisions in domains with incomplete or expensive data. Simple models frequently fail to capture critical attributes of the real world. In high-stakes applications (e.g., power plant operation, military supply chain, advanced manufacturing lines, large-scale financial portfolios), even moderate trial-and-error can be prohibitively costly.

Further, existing techniques often result in domain-specific or “bespoke” solutions that do not generalize. Real-world models are highly context-dependent, and the engineering work to adapt a prior approach from, for example, controlling a chemical process to scheduling flights for an airline may be so large that each project is built from scratch.

Accordingly, there is a need for systems and methods as described herein.

### SUMMARY

Systems and method of the subject technology provide advantages in developing and using real-world models by (1) combining domain-expert knowledge and large language model-derived knowledge into Bayesian priors, (2) synthesizing these priors with observational data for model updating, and (3) using generative reinforcement learning—potentially in either an online (continuous updating) or offline (batch) mode—to safely explore counterfactual policies at scale. The subject technology can greatly reduce the time and cost of building an accurate digital twin-like model, ultimately enabling automated planning solutions for previously intractable domains.

In one embodiment, a method generates a predictive model based on a Bayesian inference algorithm (such as stochastic variational inference) that uses observation priors and generative priors (discussed below) and is applied to both domain-expert input and large language model (LLM) outputs. The predictive engine or predictive model iteratively evaluates counterfactual scenarios against a cost function and set of constraints. The predictive engine can use a state evolution model representing a parameterized model—statistical, neural, graph-based, or hybrid—that estimates how the underlying state of a domain changes in response to actions or external factors. By simulating multiple possible actions (or policies), the method identifies near-optimal strategies for achieving user-defined objectives. The predictive model is then updated with real data, such as sensor inputs or enterprise system records, in either a continuous online mode or an offline batch mode, thereby improving the fidelity of the predictions and planning outputs over time. Thus, it can be understood that the predictive engine or predictive model can refer to a computational implementation of the state evolution model integrated with an observation model that maps real-world sensor or record data to internal state variables.

In various embodiments, observation priors capture correlated variables (e.g., from historical domain data), while generative priors capture how the world evolves (e.g., from LLM-derived knowledge of physics, processes, or logistical relationships). The term observation priors may refer to probability distributions that encode correlations among variables observable in a real-world domain, such as sensor measurements, historical system records, or enterprise database attributes. The term generative priors refers to probability distributions describing hypothesized relationships or causal structures governing how a domain evolves over time, such as physical constraints, operational rules, or expert-defined causal assumptions. Both priors are fed into a Bayesian inference pipeline to build a robust predictive model. This combination vastly reduces the data requirements (the “cold start” problem) and lessens the need for risky or expensive real-world experimentation. Further embodiments include hierarchical or multi-agent reinforcement learning setups, real-time sensor feedback loops, and safety-critical constraints to ensure reliability in mission-critical domains.

A system consistent with these principles can be deployed across multiple industries: from logistics and operations to finance, energy, healthcare, or any other domain that benefits from accurate decision-making under uncertainty. The approach is “domain-independent” in the sense that it only requires customizing priors and sensor integration rather than rewriting the underlying reinforcement learning or Bayesian algorithms for each new environment.

An embodiment of this system may generate data through offline simulations or synthetic scenarios, incorporate it into a reinforcement learning engine, and converge on recommended actions that optimize cost or performance metrics. It can provide these recommendations to human users and collect subsequent real-world performance data to refine the model. Over time, the system learns a more accurate digital twin of the domain, informed by both human experts and measured data, enabling continuous improvements in decision-making.

Accordingly, the subject system and methods described herein include: (i) methods for combining large language model outputs and domain-expert knowledge as Bayesian priors, (ii) a simulation-based generative reinforcement learning engine that evaluates counterfactual policies in a safe environment, (iii) repeated model updates from sensor streams or enterprise databases using approximate Bayesian inference, and (iv) the ability to operate in offline or online modes, handling low-data or high-risk scenarios.

One embodiment includes a system or device that includes one or more computer systems configured to perform one or more methods as indicated above.

Another embodiment includes a non-transitory medium storing data that includes one or more instructions, which when executed cause one or more processors to perform one or more methods as indicated above.

Additional and alternative aspects will be apparent on review of other portions of this disclosure.

### BRIEF DESCRIPTION

So that those having ordinary skill in the art, to which the present disclosure pertains, will more readily understand how to employ the novel system and methods of the present disclosure, certain illustrated embodiments thereof will be described in detail herein-below with reference to the drawings, wherein:

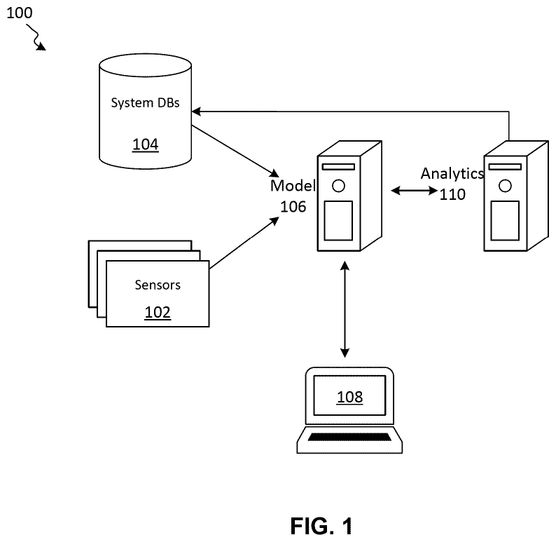

FIG. 1 illustrates a block diagram of an example system of the disclosure.

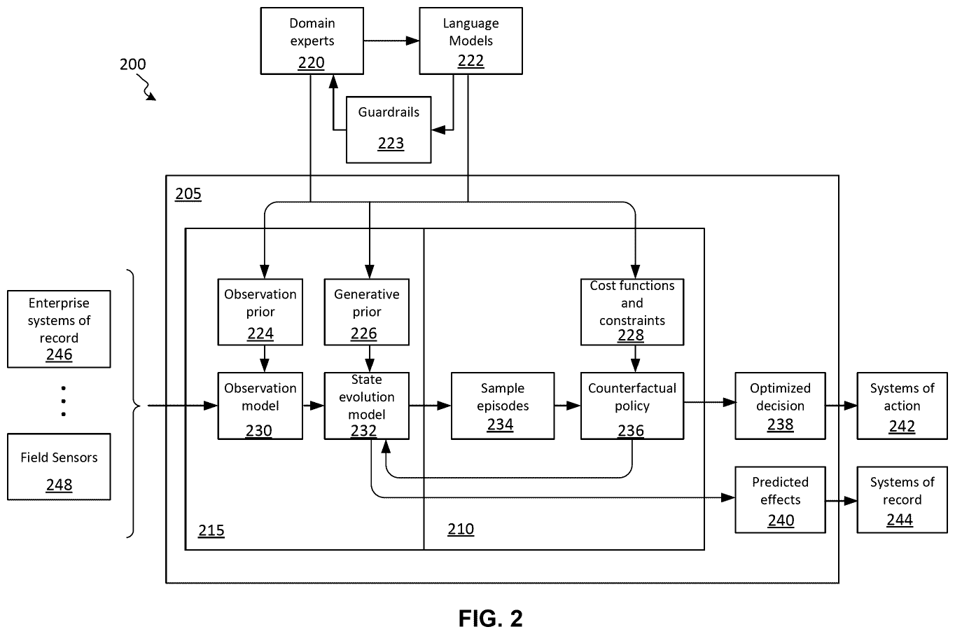

FIG. 2 illustrates a block diagram of an example system of the disclosure.

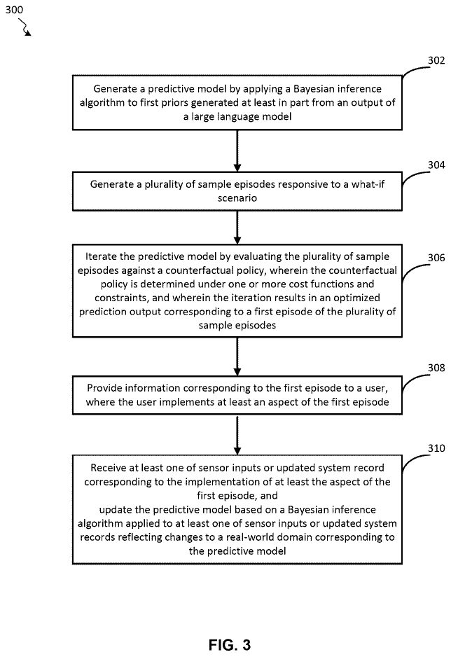

FIG. 3 illustrates a flow chart of an example process of the disclosure.

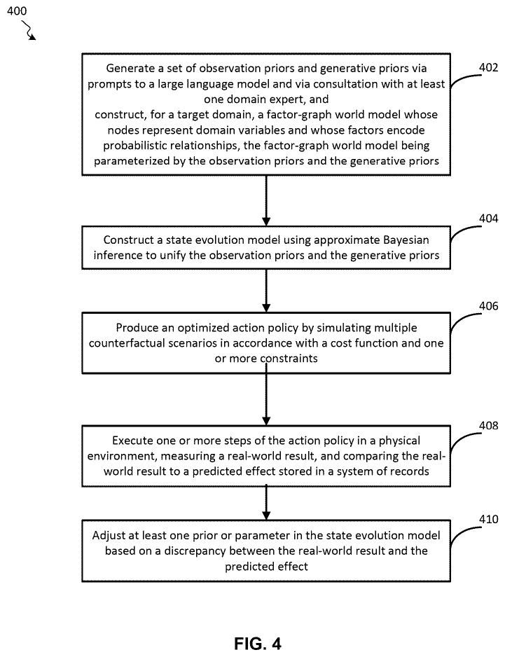

FIG. 4 illustrates a flow chart of an example process of the disclosure.

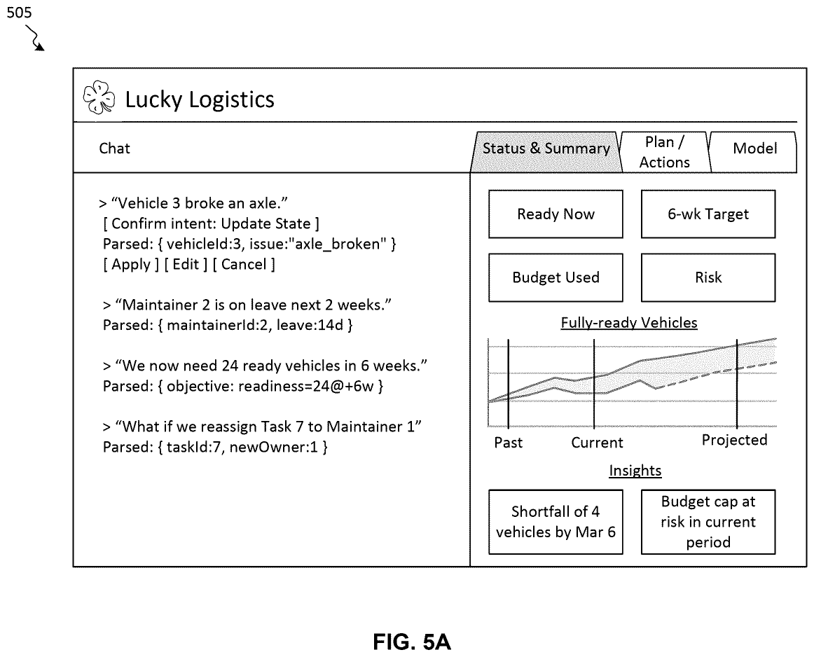

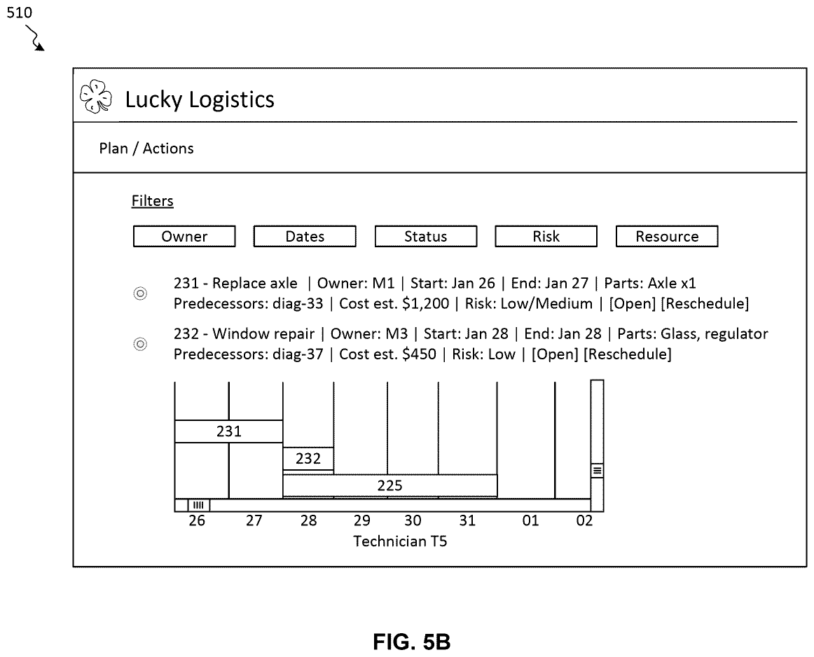

FIGS. 5A and 5B illustrate example user interfaces, in accordance with one or more embodiments.

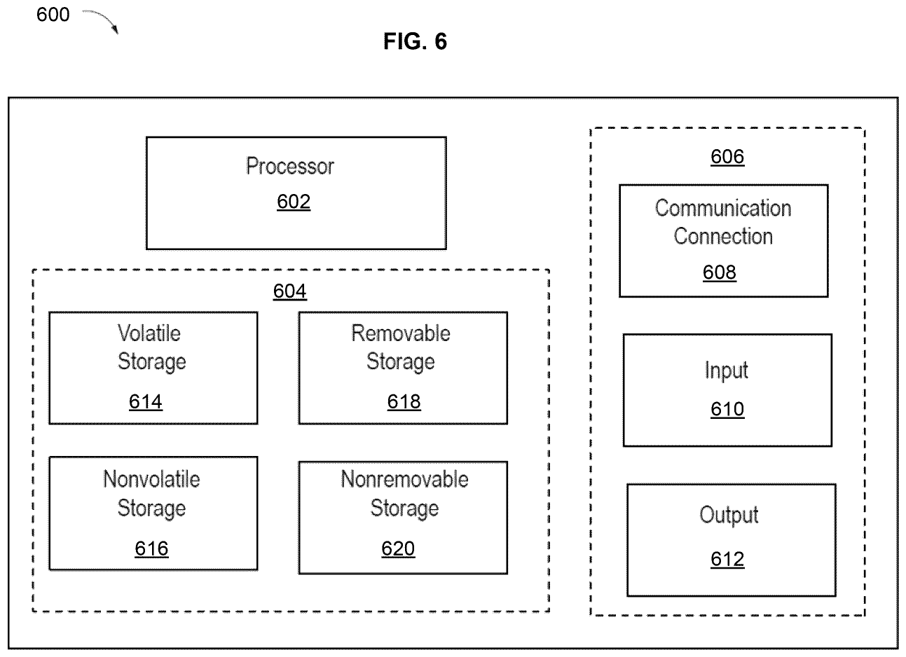

FIG. 6 is a block diagram of a device system that may be used to implement at least a portion of aspects herein.

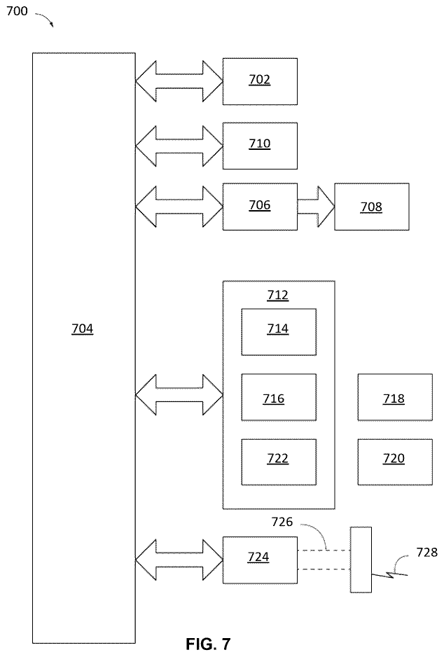

FIG. 7 is a block diagram of a computer-based system, in accordance with some embodiments.

### DETAILED DESCRIPTION

Aspects herein generally relate to combining expert-derived and large language model-derived priors into a Bayesian predictive model and leveraging that model within a generative reinforcement learning (RL) framework. The approach greatly improves performance in real-world domains where data is scarce, experiments are costly, and operational constraints are strict. Unlike purely model-free reinforcement learning, which often relies on extensive direct interaction or simulation, the disclosed systems and methods use preexisting knowledge to reduce training time and errors.

As a brief overview, aspects of the subject technology implement a predictive engine that attempts to model a real-world domain (e.g., develop a digital twin) by deriving a set of priors from domain experts and/or from large language models. Information from the domain experts and/or the large language models may be filtered through a Bayesian inference algorithm, such as a stochastic variational inference (SVI) algorithm. This data is used to establish initial or soft priors for a prediction engine which is derived from the priors. Testing scenarios for the prediction engine can be generated and used in reinforcement learning to find an optimized solution to a goal. As an example, testing scenarios can be generated using available inputs and varying valid values for the available inputs. Reinforcement learning can be performed based on the based on the optimization of the testing scenarios. Optimized scenarios can be used as predictions for how to manage the domain in the real-world, for example, for resource planning and logistics. Actual changes to the real world that are relevant to the domain can be captured by sensors and/or reflected in records. The priors and/or observation models can be updated based on Bayesian inferences, such as SVI algorithms, applied to the real-world data captured by the sensors and/or the records inputs, thereby improving the model through updating the priors with real-world data when available without having to retrain the predictive model.

Embodiments of the subject technology can be understood from a number of example use cases. It should be understood that the following use case examples are not intended to be limiting, but that these examples are intended to provide some context for better understanding and explanation.

Embodiments can be implemented in the field of industrial logistics and operations. For example, suppose a global supply chain manager wants to optimize warehouse layouts and reorder points. Traditionally, they rely on either rules-of-thumb or purely data-driven models that cannot adapt to new SKUs quickly. Using implementations of the subject technology, the manager or an engineer encodes domain insights (e.g., certain items are always stored together, seasonality constraints) as priors; a large language model can provide general knowledge of supply chain best practices. The system merges these priors with limited real data (e.g., from sensor-equipped forklifts or ERP records) and then runs generative reinforcement learning to find near-optimal reorder thresholds and item placements.

Embodiments can be implemented in the field of fleet operations and maintenance. In some instances, such embodiments can be implemented in an online or real-time environment such that reinforcement learning is continuous. For example, suppose for aircraft readiness or fleet vehicle scheduling, the cost of an unplanned failure is extremely high. Implementations of the subject technology can continuously assimilate sensor streams (e.g., engine data, maintenance logs) to update the predictive model in near-real-time. Expert knowledge about critical operating thresholds plus LLM knowledge about maintenance intervals yield initial generative and observation priors. Reinforcement learning based on generated scenarios suggests scheduling actions (maintenance, dispatches, part replacements) that minimize downtime, subject to safety constraints and/or external regulations. It should be understood that embodiments may also or instead be implemented in an offline or batch mode such that the reinforcement learning occurs at intervals, such as described in the following example.

Embodiments can be implemented in the field of healthcare or medical device management. In some instances, such embodiments can be implemented in a periodic offline or batch mode such that reinforcement learning is periodic or incremental. For example, suppose that in a healthcare setting, collecting real-time trial-and-error data can be unethical or otherwise infeasible. Offline/batch reinforcement learning can be used to process data periodically or in intervals. For example, large corpora of historical patient data plus clinicians'knowledge can be used to train an initial model. A large language model's medical guidelines or best practices can further inform priors. The system simulates potential treatment plans offline, produces an optimized policy, and updates the model only when new clinical data becomes available—without risking real patient harm in the exploration stage. It should be understood that in such embodiments or in uses involving medical information, best privacy practices and legal compliance with privacy laws having to do with medical information may be implemented (e.g., HIPAA, GDPR, or domain-specific regulations), depending on jurisdiction. For example, medical data can be anonymized and/or additional privacy measures can be used.

Embodiments can be implemented in the field of financial portfolio management. For example, suppose that domain experts in finance have tacit knowledge of market structure and risk factors that an LLM can supplement with broad economic knowledge. Implementations of the subject technology can produce a Bayesian prior for how assets co-vary over time, then run generative reinforcement learning to test portfolio rebalancing strategies. Data may be updated from actual market feeds, and the system can remain robust even during rare market conditions if priors encode relevant expert insights which may be affected during such times, such as liquidity risks.

As can be seen in this disparate set of examples domains and use cases, the subject technology can be used across a broad spectrum of domains, and is essentially domain agnostic. Minimal adaptation of the system includes defining priors, defining a cost function, determining a source of a stream of real (or offline) data, and determining one or more actions that can be taken that can be evaluated to predict their effectiveness, e.g., using the cost function. For example, in the domain of portfolio management, the actions may involve trade decisions. In the domain of supply chain logistics, the actions may involve ordering decisions. In the domain of healthcare diagnostics, the actions may involve treatments.

FIG. 1 illustrates an example system 100 for training and performing generative reinforcement learning of a predictive model, using field sensors, enterprise system data, domain-expert knowledge, and large language model outputs. The system 100 may also utilize the predictive model to generate a prediction for implementation. Further, for implemented activities, whether as a result of an implementation done according to a prediction or for other activities unrelated to the predictive model, data resulting from the implemented activities may be captured by the system 100 and stochastic variational inferences can be drawn from the captured data. Thus, rather than capture all data to iterate the predictive model, captured data is evaluated to determine stochastic variational inferences so that the subset of captured data which is used to alter the predictive model tends to infer data about the real-world of the pertinent domain which is relevant to update the predictive engine via updated priors based on the captured data.

System 100 includes sensors 102, one or more of which can be associated with one or more physical locations, physical assets, uses of physical items, and so forth. The sensors contemplated by the illustrated sensors 102 can correspond to any sensors pertinent to the domain which is being modeled. Some sensors may correspond, for example, to video inputs which can utilize separate object identification algorithms to track people and or objects captured by the video inputs. Some sensors may be microphone sensors, which can capture and model audio data, using separate audio processing algorithms to characterize the sounds captured by the microphone sensors. Some sensors may correspond to scanners, for example, inventory scanners for scanning bar codes or QR codes or other coded information. Some sensors may correspond to weather sensors, such as temperature, pressure, and humidity sensors, and the like. Some sensors may correspond to GPS location or other location sensors. Some sensors may correspond to RADAR or LiDAR sensors, sonar sensors, proximity sensors, and so forth. Some sensors may correspond to gate access sensors and the like. Additional types of sensors may be used. A combination of any of the above sensors may be used in any quantity and combination. Sensors 102 collect data regarding the physical properties of the domain which is being modeled. Sensor data from sensors 102 can be provided to one or more of sensor databases (not shown) and/or a model server 106.

The system database 104 may include information stored thereon reflecting variables and data regarding the modeled world. The system database 104 can also include records related to actions taken in the domain, including one or more actions taken and one or more results resulting from the actions taken. The system database 104 can also contain the data from sensors 102 and/or one or more models of the domain. The one or more models of the domain, for example, can include information correlating various sensor inputs from the sensors 102, information regarding variables in the domain, and information indicating how the variables in the domain may interact, if known. The system database 104 may include one or more computing devices.

The model server 106 may correspond to a server that generates and/or updates and stores a predictive model of the world of the domain which is based upon information provided by the data from sensors 102 and the system database 104. The information, for example, can correspond to information priors sourced from large language models and/or domain experts. The information priors can be used to initially establish the predictive model and the data from sensors 102 and/or information from the system database 104 can be used to update, i.e., generatively train, the predictive model.

The system 100 can include one or more user devices 108, e.g., computers, that can be used to query the model server 106 to initiate predictions utilizing the predictive model of the model server 106. The system 100 may provide an interface that includes queries to the predictive engine which take various forms. One form, for example, may be to run a query for a specific proposed action. For example, if the domain corresponds to a logistics and operations system, one may query whether to restock one product before another. Another form, for example, may be to run a query that inquires about an optimization effect. For example, in the example logistics and operations system, one may query whether a change in a warehouse layout would increase efficiency. In another example, one may query what would be the next recommended action which would maximize an increase in optimization at the lowest cost. An optimization function associated with the predictive engine can be used to suggest one or more actions to be taken which, if realized, would provide greater optimization of the domain (i.e., the “world” for that domain) according to the optimization function.

The system 100 can further include an analytics server 110 which can perform reinforcement learning through cost function evaluation of a predictive outcome of the predictive engine. The analytic server 110 can run iterations through the predictive engine to evaluate the output of the predictive engine using a cost function. The analytics server 110 can further supply updated records to the system DBs 104 for changes made to the domain, e.g., the real world. The analytics server 110 may be a separate server or set of servers from the model server 106 or may be implemented on the model server 106, for example, as a module of the model server 106.

FIG. 2 illustrates a block diagram showing the interplay of observation priors, generative priors, reinforcement learning, cost functions, and the counterfactual policy engine to arrive at an optimized decision. FIG. 2 illustrates a more detailed diagram of system 200 of certain aspects of the functional components of the system 100. Various aspects of FIG. 1 may be omitted for clarity. A brief overview is provided before examining each of the aspects of FIG. 2 in detail.

Element 205 corresponds to a predictive model solution for predicting outcomes in a modeled domain. Various inputs are provided to the element 205, which are used to generate the logic of the predictive model, update the predictive model, or utilize the predictive model. Element 205 includes a Bayesian inference component 215 and a reinforcement learning component 210.

Inputs provided to the predictive model solution illustrated by element 205 include information from domain experts 220 and information from language models 222. Inputs can therefore inherently include historical action of the world, being a mix of tribal knowledge, expert knowledge, disparate sources of authority. FIG. 1 and FIG. 2 outline a methodology by which domain experts 220 and large language model 222 outputs feed into and form observation priors 224 and generative priors 226. The method uses approximate Bayesian inference—like stochastic variational inference (SVI)—to unify these priors into two principal models. An observation model 230 correlates sensor data or historical enterprise records with underlying variables of interest. A state evolution model 232 encodes how the domain evolves over time in response to different actions or external factors.

In the disclosed system, approximate Bayesian inference provides a mechanism that integrates generative priors 226 generated based on expert-derived knowledge (e.g., via the domain experts 220) and LLM-derived knowledge (e.g., via the language models 222), with observational data (e.g., via the observation prior 224 block and observation model 230 block). In one implementation, a stochastic variational inference (SVI) procedure receives the observation priors and generative priors as initial distributions, along with available historical or streaming sensor data. The SVI algorithm updates the parameters of both the observation model and the state evolution model by minimizing a divergence measure between the model's inferred distributions and the true (but unknown) posterior over domain dynamics. This approach permits the system to quantify uncertainty associated with expert inputs, filter noise or inconsistencies in LLM responses, and progressively refine the predictive model as additional real-world data becomes available. Through repeated inference cycles, the system converges toward a more accurate and data-efficient representation of the modeled domain.

In some embodiments, an LLM is used to generate structured information that contributes to the generative priors. For example, domain experts may supply prompts asking the model to identify factors influencing system behavior, causal relationships among operational variables, or typical ranges for domain-specific parameters. The LLM's textual output is then transformed into a formal representation, such as a factor graph, dependency matrix, or parametric distribution that can be ingested by the state evolution model 232. The Bayesian inference engine can assign initial uncertainty weights to this LLM-provided structure and update these weights as real-world data is incorporated. Uncertainty weights may correspond to scalar or vector parameters associated with individual priors (observation or generative) that quantify confidence in the prior and are updated by the Bayesian inference algorithm as additional evidence is ingested. This process ensures that LLM output is treated not as deterministic ground truth but as a soft prior that is validated or revised according to objective measurements from the modeled environment.

The Bayesian inference algorithm can maintain uncertainty weights for each prior (e.g., per factor or edge in the factor graph). Upon ingesting new sensor or record evidence, the algorithm can update posterior distributions and adjust the associated uncertainty weights by increasing weights on priors whose induced predictions match observations and decreasing weights on priors with systematic residual error. The weights are then used in subsequent episode generation to bias sampling toward higher-confidence dynamics, thereby reducing variance and compute load in policy evaluation.

The input to the language models 222 and the output from the language models 222 can be subject to guardrails 223. Guardrails include (i) LLM guardrails that pre-process prompts and post-process LLM outputs to filter prohibited content, hallucinations, and violations of technical or policy constraints, and (ii) action guardrails that restrict policies to a safe action region via constraint enforcement (e.g., action masking, barrier penalties, or Lagrangian relaxation). The safe action region or safe region of the action space can correspond to a machine-enforced subset of actions computed from constraints that include at least one of: technical manual rules, resource capacity limits, regulatory thresholds, or learned risk bounds; actions outside the safe region are excluded from simulation via action masking or penalty barriers. For example, prior to implementing out a sample episode, the simulator computes an action mask M over the discrete or discretized action vector A according to the above-referenced constraints (e.g., safety limits, capacity bounds, or technical manual rules). The mask M may be applied at each simulation timestep so that only actions within the safe action region are enumerated or sampled. This pre-filtering avoids generating trajectories that would be later discarded, reducing the number of successor states explored and the compute cycles consumed during policy search. By computing and applying action masks before trajectory expansion, the system deterministically prunes unsafe or infeasible actions and thereby reduces successor-state enumeration, decreasing CPU/GPU cycles and memory allocations per episode.

The guardrails 223, for example, can ensure that the input to the language models 222 does not violate terms of service and is provided in a manner that improves the quality of the output of the language models 222. The guardrails 223 can also be used to filter or refine the output of the language models 222 to handle unwarranted hallucinations that may occur when using generative artificial intelligence output.

In some embodiments, for example, by-domain factor graphs can be created to facilitate modeling. A factor-graph world model or domain model is a probabilistic graphical model whose nodes represent domain variables and whose factors encode potentials over subsets of variables. The factor-graph world model parameterizes both the state evolution model and the observation model; edge weights and factor potentials are initialized from observation and generative priors and updated by approximate Bayesian inference. Factor graphs can be reviewed and/or modified by domain experts as a friendly representation of the factors generated and their potential values.

The factor-graph world model may be stored in a sparse representation (e.g., compressed sparse row/column) and may be evaluated in a topologically sorted order per connected component. Marginal computations may be batched and vectorized to exploit data locality and parallelism (e.g., SIMD or GPU kernels) to reduce memory footprint and cache misses relative to dense representations when the domain graph is sparse.

As an example embodiment, consider the use case domain corresponding to maintaining vehicle readiness of a fleet of vehicles, such as military vehicles. Readiness can be driven by maintenance actions. Factors for the factor graphs can include, for example, the availability of maintenance workers, the workload of maintenance workers, the productivity/efficiency of maintenance workers, the availability of parts and consumables, the locations of stores of parts and consumables, the cost of work, the cost of parts, the statuses of assets (e.g., issues and readiness of each vehicle in fleet considered by model, and specific maintenance factors for each), and so forth. The factor graphs may determine a metric associated with each factor on which the factor can be evaluated and a generated value for each factor based on the LLM output in conjunction with the available priors. Factors that do not have available priors or have fewer available priors can be weighted less and factors with more information in the available priors can be weighted greater. The factor graphs can further be used in developing the cost functions and constraints 228, discussed in greater detail below. In some instances, factor graphs can be learned and/or updated via Bayesian updates from real-world outcomes mapped to the factor graphs (e.g., node/edge parameter posteriors) and not only specified by experts and/or LLMs.

A dependency matrix can also be provided which provides a prediction of which factors are interlinked such that a movement in the value of one such factor would implicate a corresponding movement, in the same or opposite direction, as another factor. Or in other words, which factors are causally linked and a predicted strength of the causal link. For example, two factors may be weakly linked when movement in one may result in a 10-40% movement in another, moderately linked when movement in one may result in a 40-70% movement in the other, and strongly linked when movement in one may result in a 70-100% movement in the other. As priors are refined through real-world data or other domain-expert inputs, as discussed in further detail below, the dependencies of the factors may also be refined.

Thus, factor graph factors/edges can be understood as instantiating parameters of the state transition distribution, while dependency strengths set prior covariances and constraint couplings used during simulation.

Moving onto the reinforcement learning component 210, once the models are defined, the system can generate “sample episodes” 234 to explore how different policies might unfold. Sample episodes may refer to simulated trajectories generated using the predictive model to estimate the effects of hypothetical (e.g., counterfactual) actions. Each sample episode, for example, can vary one or more of the values in the factor graphs to determine a prediction of an outcome under such an episode. Thousands of sample episodes 234 can be run at high speed to determines predictions of courses of action based on simulation. Such simulations predict futures probabilistically based on particular courses of action. In other words, the simulations predict an outcome in the world of the domain corresponding to an actual course of action taken. Courses of action simulated can include optimal or otherwise superior courses of action, as assessed based on various parameters or constraints, as well as sub-optimal courses of action, such that optimal or preferred courses can be selected. An optimal future (e.g., the optimal decision 238) can be selected based on objective in view of cost function minimizing cost and/or risk, i.e., as a reward function. One or more optimal or superior courses of action or futures can vary, based on the same simulation of the same courses of action, based on selection of parameters or constraints to be optimized (e.g., modifying the reward function).

The sample episodes 234 are evaluated under a counterfactual policy 236 which utilizes cost functions and constraints 228 that are provided at least in part by the language models 222. In this context, a counterfactual policy is a policy generated by evaluating multiple hypothetical action sequences under simulated conditions, a cost function, and one or more constraints. Thus, the counterfactual policy is a policy that is not deployed in the physical environment during evaluation, but is instead evaluated within the predictive model by simulating one or more hypothetical action sequences to estimate their effects subject to specified cost functions and constraints. The counterfactual policy 236 is used to evaluate potential courses of action by generating simulated trajectories (“sample episodes”) based on the predictive model. Each sample episode represents the predicted evolution of the domain under a specific sequence of hypothetical actions. A cost function, which may incorporate performance objectives such as efficiency, reliability, readiness, or safety, is applied to each episode. Constraints—such as regulatory limits, risk thresholds, or operational boundaries—are enforced either by restricting the action space or by penalizing constraint violations during evaluation. The engine iteratively scores and compares episodes, identifies near-optimal policies, and outputs a recommended action or action sequence. Because these evaluations occur within the simulated environment, the system can explore a wide range of potential decisions without causing real-world harm or incurring significant experimental cost.

In one or more implementations, the evaluations can provide a set of prediction outputs, where each prediction output in the set corresponds to a sample episode that meets a threshold score, where a threshold score corresponds to a machine-readable boundary condition stored in the model configuration, such as a numeric scalar, vector bound, or logical predicate used to filter, rank, or accept results deterministically. A selected optimized prediction output can be selected from the corresponding subset of sample episodes that meet the threshold. The selection can be random or can be made according to a secondary optimization, such as, by ranking the subset of sample episodes by implementation cost, estimated savings, time frame, complexity, and so forth. In one or more implementations, the subset of sample episodes can correspond to a predetermined number of the be the highest scoring prediction outputs, such as twenty or fifty (or another number).

The optimized decision 238 block represents one or more hypothetical actions which minimize cost or maximize utility, from which a system of actions 242 can be derived. For example, if the cost function indicates that warehouse inventory should be repositioned to increase efficiency, the system of actions 242 corresponds to the processes by which the inventory should be repositioned. For example, the actual order of repositioning the inventory can be captured in the sample episodes which lead to the optimized decision 238. As the real-world actions are implemented which may follow or deviate from the system of actions 242, the predicted effects 240 of those actions can be modeled using the state evolution model 232 and systems of record 244 can be observed which can be used to feed back to alter that observation model 230 and/or observation priors 224. If the systems of action 242 are fully or partially implemented in the real world, the resulting data—whether from sensor logs 248 or enterprise records 246—feeds back into the Bayesian updating procedure, refining the priors and the state evolution model over time. The systems of action 242, for example, can be provided to an implementation system that executes actions produced by the optimized policy, according to the sample episode selected from the optimization. The implementation system can implement at least an aspect of the selected sample episode. The implementation system can include devices and computer systems such as a manufacturing execution system, computerized maintenance management system, workflow/orchestration service, robotic process automation engine, programmable logic controller, or supervisory control and data acquisition interface.

Thus, actual outcomes are still ingested but time, expense, and real-world constraints may limit the use of outcome data for reinforcement learning, such that generally actual outcomes are not integrated into the reinforcement learning. In other words, real-world outcomes primarily update the Bayesian model (e.g., by refining the priors), while reinforcement learning may then use the updated model. In some embodiments, offline reinforcement learning can also use logged data. Thus, actual outcomes can be parameterized and input to train the language models 222 and/or observation models 230 to become priors for the state evolution model.

The system and methods contemplated by the diagrams of FIGS. 1 and 2 can include two modes, which may be used independently or in conjunction. These modes include offline (batch) modes of operation and online (real-time) modes of operation. In the offline mode, the predictive model may be built or updated using fixed historical datasets or curated logs where real-time experimentation is impractical or unsafe. Offline updates may occur periodically, such as after a threshold volume of data has accumulated. Thus, in the offline or batch mode, the system may ingest historical data once using a static offline mode of operation to build or update the predictive model, and then propose an update policy that does not utilize live feedback. This approach may be used, for example, in domains (like healthcare) where experimentation is risky or heavily regulated. New historical data can be gathered or captured over time and in a subsequent update, the system may ingest the new historical data utilizing the reinforcement learning processes described herein. For example, when the input or record data is sensitive or requires curation prior to ingestion, the system may use fixed logs of historical data for training; no live exploration is performed. Logs can be curated to protect privacy and used in a batch or periodic-offline update process. A generative simulation environment is built from the Bayesian model, enabling safe policy search.

In contrast, the online mode processes sensor streams or enterprise records as they are received, updating the observation and generative priors continuously or at predetermined regular (e.g., hourly, daily, or weekly) intervals. In the online or real-time mode the system continuously monitors sensor data (e.g., from Internet connected devices), updating the model at regular intervals, milestones, or in near-real-time. The online or real-time mode is well-suited for industrial processes or fast-moving logistics. For example, periodic updates can happen as sensor data streams arrive. Implementations can ensure new data is integrated via Bayesian updates without discarding prior knowledge or requiring a full restart of training.

When the system operates in a hybrid mode, certain data sources—such as sensitive medical records or intermittently connected devices—may update in batch form, while streaming data sources provide continuous real-time feedback. Regardless of mode, the Bayesian inference engine incorporates new information without discarding accumulated knowledge, enabling the predictive model to adapt responsively to changing conditions. For example, a combination of the online and offline modes can be used when some input data is sensitive or otherwise unavailable, such as being sourced from a sensor or data source that is not network connected, while other input data can be taken in near real-time.

In some aspects of the subject technology, hierarchical or multi-level reinforcement learning may be used, for example, in more complex domains. For example, a top-level policy may be used to set strategic goals while lower-level policies handle shorter-term control decisions. The same Bayesian priors and generative modeling approach apply, but the system is broken into multiple “layers” or sub-models. This can reduce computational overhead and provide better interpretability.

In online or hybrid modes, the system may perform incremental stochastic variational inference (SVI) in minibatches using the previous posterior as the initialization point for each update cycle. This warm-start avoids full retraining, reduces the number of optimization steps required for convergence, and enables low-latency assimilation of new feedback while the system remains available for episode generation.

In some aspects of the subject technology, multiple experts and/or multiple large-language models may be used. For example, for domains requiring broad coverage, the system can ingest knowledge from multiple experts and from more than one large language model, forming an ensemble of priors. In one or more embodiments, one or more of the experts may correspond to an agent that can run on a large language model using tools to mimic a domain-expert. An approximate Bayesian method can weigh the reliability of each prior, effectively learning how different pieces of expert or LLM-derived knowledge should be integrated.

Still with reference to FIG. 2, the elements illustrated in FIG. 2 are discussed in greater detail. Inputs can therefore inherently include historical action of the world, being a mix of tribal knowledge, expert knowledge, disparate sources of authority.

Domain experts 220 can correspond to experts for the world being modeled (e.g., the “world” for that domain). For example, in the example field of industrial logistics and operations, the domain experts 220 can correspond to logistics engineers. In the example of fleet operations and maintenance, the domain experts 220 can correspond to mechanics. In the example of healthcare or medical device management, the domain experts 220 can correspond to doctors, nurses, and/or device technicians. In the example of financial portfolio management, the domain experts 220 can correspond to financial planners and financial advisers. The domain experts 220 utilize domain expertise to help determine prior distributions over how the world captured in the predictive model evolves and how to interact with it. In addition, language models 222, such as a large language model, can be used to provide general knowledge which is not necessarily domain specific to the prior distributions. In some instances, domain experts 220 or others can utilize the language models 222 by engaging in prompt engineering to develop prompts for mining data out of the language models which is relevant to the prior distributions.

Thus, domain experts contribute qualitative and quantitative insights that improve the fidelity of the priors used to initialize the predictive model. Such expert knowledge may define probable causal mechanisms, operational heuristics, environmental constraints, or relationships that are not readily deducible from limited datasets. These can be provided, for example, by experts into an LLM interface, and the system converts these inputs into structured priors—such as distributions over wear-rates, demand curves, or equipment degradation patterns—that reflect the expert's understanding of the domain. During Bayesian inference, these priors may serve to guide the system toward plausible models even when empirical data is sparse. As more data becomes available, the system automatically adjusts the weight assigned to expert-defined priors, ensuring that the predictive model evolves in alignment with observed real-world behavior.

As noted above, guardrails 223 can be implemented. Guardrails can be implemented to address potential problems with inputs or outputs to or from the language models 222. Guardrails can also be used to address policy constraints, such as regulatory constraints and action constraints. In the case of the language models 222, embodiments can mitigate large language model hallucinations through the use of guardrails 223 that can pre-process input to the language models 222 and/or post-process output from the language models 222. Large language model hallucinations can unintentionally cause a violation of various technical manual protocols, operating procedures, orders, maintenance worker availability, other constraints. Systems of actions 242 that are assigned based on hallucinations are problematic because scheduling maintainers to perform certain actions and telling them the actions to perform can be contrary to an optimized solution. Issues include over-assignment of maintainers, exceeding budget, violate technical manuals, unwarranted orders, lack of orders, and so forth. Guardrails 223 can be implemented in a hybrid approach, utilizing both algorithmic solutions to catch hallucinations or violations of use and human intervention. For example, output can be provided back to the domain experts 220 prior to integration as a generative prior or cost function for approval, e.g., in a human in the loop or a human on the loop implementations. In other instances, guardrails may be enforced in a human not in the loop implementation. In a human in the loop implementation, humans, such as domain experts, actively participate in the guardrail implementation to provide validation and supervision to improve AI model safety and reliability. Humans can bridges the gap between automation and human expertise. In a human on the loop implementation, automation operates independently, but humans, such as domain experts, monitor or override decisions to ensure safety and accuracy. Human on the loop implementations allow faster automated decision making, but allowances for human intervention. In a human not in the loop implementation, a human does not participate in guardrail decisions except to review historical triggering of guardrails to determine if they are being implemented effectively in an automated way. In some instances, for example, algorithms can cross check output from the language models 222 for terminology that does not make sense in the domain or second LLM can be used as a guardrail system to evaluate input or output to or from the other LLM.

With respect to policy and action guardrails, algorithms or secondary language models can be used to detect when input to the LLM or output from the LLM would violate a policy of the organization. Some policies may be inheritable from a third-party guardrail provider, for example, tuned to operate in a particular regulatory framework. Other policies may be organization specific or developed by the organization to prevent sensitive information or repugnant information from being provided to or received from the language models 222. Thus, guardrails 223 can ground recommendations and/or scheduled actions to ensure that they actually create value over current state/status quo and do not violate key rules, such as regulatory rules that may be jurisdiction specific, privacy rules that may seek to protect or safeguard personal information of users or public figures that may be obtainable from the language models, misuse rules based on illegal or immoral activity, or political rules that seek to reduce risks associated with being seen as being politically active.

The observation priors 224 developed can provide correlated data points in the real world. For example, the observation priors 224 can identify sets of variables that have strong correlation. For example, in the example field of industrial logistics and operations, the observation priors 224 can identify a correlation that stock demand for a first widget is highly correlated with stock demand for a second widget. In the example of fleet operations and maintenance, the observation priors 224 can include correlations between vehicle models and downtime or between delivery areas and delivery days. In the example of healthcare or medical device management, the observation priors 224 can correspond to correlations between test results and diagnoses. In the example of financial portfolio management, the observation priors 224 can correspond to closely correlated stock prices, spending and saving behaviors, and the like. In some embodiments, observation priors 224 can be retrieved from a data source, such as sales or inventory information over a time period. Bayesian inferences, such as stochastic inferences, can be used to extract observation priors 224 from the data source to derive pertinent data to seed the observation priors 224.

The generative priors 226 can provide information about the descriptive aspects of the world being modeled. Generative priors 226 can include, for example, physical location and layout information of the world, locations of particular items in the world, and so forth. The generative priors 226 can correspond to descriptions of world features. In general, the more descriptive and complete the generative priors are, the better, however, as will be seen, one advantage of the system is the ability for the system to undergo an reinforcement learning or feedback training mechanism that updates the generative priors 226 and observation priors 224 based on real-world data. For example, in the example field of industrial logistics and operations, the generative priors 226 can correspond to an initial correlation derived from data that is between a time from order to time of fulfillment and the generative priors 226 can update and/or expand the correlation based on the reinforcement learning process. In the example of fleet operations and maintenance, the generative priors 226 can include an initial correlation derived from data between operators and assigned vehicles as a measure of productivity and the generative priors 226 can update and/or expand the correlation based on the reinforcement learning process, as new data is gathered. In the example of healthcare or medical device management, the generative priors 226 can correspond to correlations derived between a large corpus of health surveys and can be updated or expanded based on additional health surveys with refined questions. In the example of financial portfolio management, the generative priors 226 can correspond to derived correlations between news events and pricing and updating or expanding the generative priors 226 based on additional news events and pricing data. In some embodiments, generative priors 226 can be extracted from the language model 222, such as a large language model, by submitting a prompt to the large language model and performing Bayesian inferences, such as stochastic variational inferences, on the information returned based on the prompt. For example, domain experts 220 can query large language models for pertinent information related to the domain which has been collected across a large corpus of data.

The observation priors 224 can be used to generate an observation model 230. The observation model can, for example, correspond to a machine learning model or engine. The observation model can be updated using real-world observational data derived from field sensors 248, such as sensors 102 described above, and/or enterprise systems of record 246, such as business records, transaction records, inventory records, and so forth, which include real-world data relevant to the domain.

Expert knowledge can be encoded as probability distributions over physical processes, correlated variables, or domain rules (e.g., “part X always wears out before part Y,” or “operations are governed by a first-order linear model in practice”). LLM-derived priors may come from prompting a large language model with domain-relevant prompts, extracting key relationships, and converting them into structured distributions or factor graphs. Approximate Bayesian inference may then be used to filter out noise, incorrect statements, or hallucinations.

The generative priors 226 can be used to generate a state evolution model 232 corresponding to a predictive engine (or model). The observation model 230 can also be used in the creation of the state evolution model 232. Thus, the state evolution model 232 is ultimately based on Bayesian inference of expert knowledge and/or large language models rather than starting from an untrained or self-trained point. Accordingly, a predictive engine can be generated with limited or no training data, but also without the need to engage in self-learning unbound cases (which in embodied applications would be expensive and impractical to produce).

Data can be stored in factor graphs, Bayesian networks, or parametric distributions (e.g., Gaussian mixtures) that reflect domain-specific or generic relationships. Further, the state evolution model may be implemented as a neural network, a symbolic representation, or a hybrid that is partially hand-coded and partially learned.

Therefore, embodiments processes combine expert knowledge and generative models to make real-world business problems solvable with reinforcement learning from real-world data and scenarios. Embodiments use a scaffolding derived from expert knowledge to bootstrap narrow models of different problem domains from limited training data, then uses that model to solve decision-making problems in complex, real-world environments. In complex domains, such as commercial or military logistics or the operation of industrial equipment, there may not be enough data to bootstrap accurate models from scratch. Human experts can avoid this problem by leveraging contextual (and often tacit) knowledge about how the world works. By combining that mental model with real-world data, embodiments can create a quantifiable framework suitable for automated planning.

Embodiments use expert knowledge as a scaffolding to learn models of new problem domains from limited data, and then apply those models to solve decision-making problems in complex, real-world environments. Embodiment leverage at least two technical features to achieve this result. One technical feature includes approximate Bayesian inference, which can quantify knowledge distilled from large language models and/or from experts'mental models of a problem domain to achieve far greater sample efficiency than model-free or unstructured methods. Another technical feature includes simulation-based generative reinforcement learning algorithms which can identify near-optimal solutions to even very challenging planning problems without extensive real-world experimentation. Combining Bayesian inference and automated model-based planning allows embodiments to integrate observational data with expert domain knowledge and ensure good performance with limited training data or real-world experimentation. Embodiments can react faster and incorporate more data into its decisions than humans can manage, leading to near- or super-human performance, and freeing up human time for more valuable activities. Further, embodiments can provide insights that humans cannot produce by quantizing tacit knowledge, but going beyond tacit knowledge to develop deeper inferences in the real-world data which may be unobservable or surprising to humans.

The fundamental challenge in using automated planning on real-world problems is defining an accurate model of the planning domain. If one knew the true state of the world, and how the world would evolve in response to our actions, one could use general-purpose algorithms to solve planning problems. In practice, though, the true state of the world cannot actually be known (and may only be approximated, for example). The state of the world has to be reasoned based on data that may be incomplete, delayed, or incorrect. Even if the state of the world could be known, predicting the effect of any particular action or combination of actions is not as easy as it might appear, at least because the reality of how a system works can be quite different from a nominal textbook model.

Embodiments use approximate Bayesian inference techniques like stochastic variational inference (SVI) to simultaneously estimate the state of the world and the rules by which it evolves. For example, engineers or model developers can work with subject matter experts to define a prior distribution, such as the observation prior 224 and/or the generative prior 226, over possible models (such as the observation model 230 and/or the state evolution model 232) that encodes how the world is likely to work. Automated systems can then perform inferences, updating the model(s) as new data becomes available. For example, embodiments can use real-world data from field sensors, such as the field sensors 248, or systems of record, such as the enterprise systems of record 246, to make inferences about how the system works and how it would respond to changes in operations. Because embodiments can use general-purpose inference algorithms, embodiments can address new problem domains without new algorithmic development or feature engineering. Additionally, the Bayesian paradigm decouples an understanding of the state of the world from how it is observed, making it easier to adapt to the data sources available for each new user of such a system.

The predictive engine or predictive model that includes the state evolution model 232 can then be used to provide predictions regarding scenarios. For example, embodiments can utilize sample episodes 234 as counterfactual scenarios to safely explore alternate strategies to solve business problems without extensive real-world experimentation. In mission-critical domains, like planning for military logistics or controlling expensive industrial equipment, the cost of exploring the space of policies can be devastating. For example, mismanaging medical logistics can cost lives, while improperly operating equipment can cause millions of dollars in damage. Large enterprises cannot credibly use systems vulnerable to hallucinations—like large language models—or that require trial-and-error to identify bad policies, like model-free reinforcement learning.

As an initial state of the predictive engine, i.e., t=0, the predictive engine cannot be seen as being in a nascent state because, as noted above, the initial inputs inherently include historical action of the world, being a mix of tribal knowledge, expert knowledge, disparate sources of authority. However, as time progresses, at t=1, t=2, t=3, etc., the predictive engine is updated, both at a base level, e.g., by applying real-world outcomes to the generative and observed priors and using approximate Bayesian inferences, as well as by utilizing the generative reinforcement learning techniques described herein. Thus, at t=1, for example, the predictive model has iterated by ingesting real-world outcomes. At a time between t=1 and t=2, reinforcement learning is used to perform optimized predictions based on generated episodes or scenarios, resulting in an optimized set of conditions and/or plan that can be put into practice. Then, at a time t=2, the model can iterate again based on real-world outcomes. The episodes can be re-run with the iterated model and the optimized predicted outcome updated based on the new results. These processes are discussed in greater detail herein.

Embodiments can generate sample episodes, and learn from that generated sample episodes to improve operations. Having a defined cost function to optimize and defined constraints to satisfy, such as the cost functions and constraints 228, embodiments can use domain-independent learning and optimization algorithms to improve operations without requiring the manual development of heuristics for each new problem domain. Embodiments use reinforcement learning from the sample episodes to generate predictions with the predictive model when real-world data is not available or practical to provide, and then can update the model using Bayesian updates from real-world data once available to further refine the model in response to new information to refine parameters and priors, allowing decision-makers to respond quickly using the best information available.

By generating samples of how the system would respond to counterfactual decisions, embodiments can explore different policies and recommend decisions to improve performance indicators. Counterfactual policies, such as the counterfactual policy 236, may be used to seek optimization of outcomes. Unlike the rules of a game which may specify discrete rules, including what it means to “win,” the ultimate goal of real-world problems can vary. Further, the definition of a “win” can change from problem to problem. For example, one goal can be to maximize profit and another goal can be to maximize efficiency. Another goal can be to minimize overhead, while another goal can be to minimize rent. Goals can include maintaining a state of readiness, reducing labor costs, reducing carrying costs, and so forth. In practicality, the domain will drive the goals, but also the priority of the goals may be problem specific and may change from day to day.

Embodiments can generate and utilize the test scenarios, such as sample episodes 234, against a given objective, allowing users to determine a best course of action that achieves a given objective. Sample episodes can be generated by generating sets of test scenarios by systematically changing a variety of inputs to achieve many combinations of different input values, where each sample episode is some variation in an input. Simulations can be run utilizing the different scenarios to optimize which variations are more or less effective. Thus, the best course of action can be determined that achieves a given objective.

Cost functions and constraints 228 can be determined or encoded with a particular objective as a cost function. The cost function can be determined, in some embodiments, by a combination of input from domain experts 220 and by language models 222. Domain experts, for example, can develop prompts based on their expertise to query the language models 222, to develop cost functions which achieve a particular objective. Constraints can also be placed around the cost functions to limit, for example, optimization at too great of cost to other aspects of the system. Real-world applications, for example, such as controlling heavy industrial machinery or scheduling medical resources, often demand strict safety constraints. Other constraints may include regulatory, legal, or ethical constraints. The system supports constraints in the cost function (e.g., “actions cannot exceed a risk threshold”) or by using a constrained optimization approach (like Lagrangian relaxation or safe exploration). Thus, an objective can be encoded in a cost function, for example, at the cost functions and constraints 228.

Optimization, such as represented by the optimized decision 238, can be determined using any suitable optimization scheme. The set of sample episodes 234 can be iterated over to determine predicted effects 240 until the constraints are satisfied or until the constraints meet an initial threshold. Once the initial constraints are satisfied, additional solutions can be sought to further exceed the initial threshold and meet a second or third threshold. Optimization in this context can correspond to any suitable optimization scheme. For example, optimization can be geared to discrete optimization or continuous optimization. One example use is a Monte Carlo simulation to achieve a shape of a distribution of the episodes to find an optimized or solution. For example, in a logistics and operations system that marshals a thousand different SKUs or UPNs, many different items can be purchased in many different quantities. Running a Monte Carlo simulation iteratively over a vast sample size can find discrete optimization. Further, once an action is taken, the real-world conditions can change, and the predictive engine can be updated and a whole new round of simulations can be run. Other strategies can be used for continuous optimization.

Once a predicted action is determined through optimization, the predicted effects 240 for that action can be determined through the simulation and provided to a system of records 244 to save and track the determined simulation for later comparison to a real-world result if and when the action is actually taken. The system of records can include a datastore that persistently records, for each evaluated episode and/or recommended action: the episode identifier, the policy parameters, the predicted effect(s) including structured key performance indicators, and timestamps and provenance sufficient to later align predicted effects with observed outcomes.

For example, when an action is taken, the action can be stored via the systems of action 242, results from the action tracked in the systems of action 242, and later compared to the predicted effects stored in the systems of record 244. Large variations between action and prediction are unwanted and may indicate that the observation priors 224 and/or generative priors 226 may be incomplete, inaccurate, or contain an anomalous representation counter to the real-world.

As the real-world characterization represented by the state evolution model 232 evolves, the actions can include additional variables, for example, as separately coded or picked up through the enterprise systems of record 246 and/or the field sensors 248, which may have not been considered before. Thus, the sample episodes can grow to iterate over additional variable (or fewer variables) as appropriate. In such a manner, embodiments can determine action strategies that may not have been considered or even thought of previously. For example, in the example logistics and operations system discussed herein, one action may develop to move products to different spaces in a warehouse, for example, to group some items in proximity to other items to make access more efficient for like items or to pair popular items with unpopular items to reduce traffic when accessing items. In another example, a sensor input may be correlated to the consumption of a material which may then trigger actions suggestions to order additional material. As an additional example, a microphone input on a training field can approximate a number of training rounds fired in a military training exercise. While the microphone may have been placed for other reasons, as a sensor input, the data from the microphone may be correlated to the inventory trends of training rounds. Positioning training rounds from other warehouses or orders from manufacturers can be undertaken to increase efficiency of restocking training rounds to personnel.

While “digital twins” replicate a physical system in software, they often require extensive domain-specific modeling. In contrast, the subject technology implemented in the disclosed systems and methods automates model creation using domain-expert priors plus large language model outputs, then refines it with approximate Bayesian inference. This yields a domain-independent platform that substantially reduces the cost and labor required to create and maintain accurate digital twins.

While examples herein have been directed to an example logistics and operations system, as well as the other example systems discussed herein, it should be understood that a different domain may be used, such as electricity generation, trash pickup routes, product assembly procedures, medical diagnoses, hotel room assignments, airline scheduling, and so forth. Further, the same single system can be used to provide analysis across multiple locations and scenarios can be run against an organization as a whole or particular locations or functions within an organization.

FIG. 3 illustrates a flowchart of an example process 300 disclosed herein for building, iterating, and updating a predictive model in an offline or online context. In some implementations, one or more process blocks of FIG. 3 may be performed by a device, such as one or more of the devices illustrated in connection with FIG. 2.

As shown in FIG. 3, at block 302, process 300 may include the system constructs the predictive model by applying a Bayesian inference algorithm—such as stochastic variational inference (SVI)—to combine (i) observation priors and generative priors (as previously defined), (ii) domain-expert knowledge, and (iii) outputs of the large-language model. This process integrates the priors created earlier from factor-graph structures, LLM-derived causal relationships, and expert heuristics into a single state evolution model that captures how the domain behaves. As described above, this fusion of priors and observational data allows the system to avoid cold-start failure modes and produces a predictive engine that reflects both tacit expert knowledge and statistically inferred relationships.

As also shown in FIG. 3, at block 304, the predictive model created in block 302 is exercised by generating multiple sample episodes. Some may represent a simulated “what-if” scenario, for example, in response to a user inputting a what-if scenario in a large language model style chat interface, as described below with respect to FIGS. 5A and 5B. Additional sample episodes can include iterated values for the variables to simulate a wide range of possible actions and their associated outcome. These episodes use the state evolution model to roll forward the domain under different hypothetical policies, thereby creating a large set of counterfactual futures.

As also shown in FIG. 3, at block 306, each scenario is evaluated using the cost functions and constraints previously described—including guardrails on unsafe or prohibited actions—to score how well different actions perform relative to operational goals such as readiness, efficiency, risk reduction, or cost control. This iterative evaluation mirrors the reinforcement-learning process explained earlier, where the predictive engine searches for actions that maximize utility without violating constraints. This can result in an optimized prediction output corresponding to one of the plurality of sample episodes, where the optimized prediction output is a model-generated selection among evaluated sample episodes that satisfies a predetermined optimization criterion (e.g., minimizing a cost function or maximizing a reward) while satisfying all enforced constraints. The optimization criterion and constraint set are machine-enforceable and reproducible from stored parameters.

As further shown in FIG. 3, at block 308, the information corresponding to the optimized prediction output can be provided to a user, and the user can implement at least an aspect of the optimized prediction output. That is, the user may undertake tasks assigned to implement the selected sample episode, but unknown factors may cause the user to modify the plan according to real-world conditions.

As further shown in FIG. 3, at block 310, newly available real-world information—obtained via sensors, enterprise systems of record, and operational logs—may be incorporated into the predictive model using the same Bayesian inference process described in block 302. This update stage refines the priors and improves the factor-graph world model by adjusting correlations, dependencies, and transition parameters in response to observed outcomes. As explained earlier, this enables the system to continuously align its internal representation of the domain with how the domain actually evolves, maintaining model accuracy even as operational conditions change. This step also closes the loop between simulation and reality by comparing predicted effects against actual outcomes, which was discussed in previous sections on reinforcement learning, guardrails, and discrepancy-driven updates. The system can collect sensor inputs (e.g., via sensors 248) or enterprise record updates (e.g., via enterprise systems of record 246) reflecting changes to the domain, then applies approximate Bayesian inference (e.g., SVI) to refine both observation and generative priors. This can occur periodically or after certain milestones (such as a sensor or record sample size threshold is reached) (offline), continuously (online), or a combination thereof. Through repeated cycles, the predictive model becomes more accurate, enabling the system to discover policies that outperform conventional approaches—often with dramatically fewer real-world trials.

In one or more implementations, the optional process may be performed of having domain experts supply correlated variable information (observation priors) and prompting the LLM to provide general causal structures or best-practice rules (generative priors). As described earlier, these priors seed the factor graph and strongly influence initial model fidelity before extensive observational data is available.

In one or more implementations, predicted effects produced during scenario evaluation are written to records for later comparison with observed real-world results. As explained previously, this supports accountability, auditability, and future model refinement.

In one or more implementations, the optimized results identified in block 304 can be used to recommend specific actions that improve domain performance. This aligns with earlier descriptions of converting optimized policies into actionable plans, including scheduling actions, resource allocation, and logistics adjustments.

In one or more implementations, safety limits, regulatory requirements, and operational bounds serve as guardrails within the counterfactual policy evaluation. This reinforces earlier explanations where guardrails prevent unsafe schedules, improper task assignments, or invalid recommendations generated by the LLM or by unconstrained simulations.

In one or more implementations, priors from multiple human and machine sources are merged using Bayesian weighting. As described earlier, this ensemble approach increases robustness and mitigates biases or hallucinations.

In one or more implementations, the process can be expanded to multi-layer reinforcement learning structures, using high-level strategic policies to guide lower-level operational policies. This builds on previous descriptions of hierarchical planning across complex domains. For example, a series of policies can be implemented that hierarchically categorize reinforcement learning according to a nested set of counterfactual policies and optimization techniques. The nesting can reflect a priority for each of the policy goals implicated by the counterfactual policies. For example, a first policy can reflect a goal of cost savings, a second policy can reflect a goal of workplace satisfaction, a third policy can reflect a goal of increasing margin. These policies can be nested in a hierarchical fashion in an order that reflects their prioritization. In some implementations, multiple variants of nested policies can be used to develop a network of priors, which can further be weighed, as indicated above.

In one or more implementations, the recommended actions are executed in the physical world and their real outcomes are measured over time. This real-world performance is compared to predicted outcomes and used to update model parameters, improving future predictions and policy recommendations. This carries forward earlier discussions on discrepancy analysis and continuous refinement of the state evolution model.

The predicted effects can later be compared, for example, to actions actually taken to determine if the predicted effects were accurate. In another implementation, the process 300 may include utilizing the predictive model to determine one or more actions to improve at least one performance metric of the real-world domain, wherein the performance metric includes one or more of cost, efficiency, readiness, or safety. For example, the predictive model can provide, through the optimization, a suggested action corresponding to one or more of the scenarios to take to achieve a predicted outcome. The optimization can relate to a cost function that is designed to improve cost, efficiency, readiness, or safety (or a combination of one or more thereof). Other factors may also be considered for improvement in the cost function.

In one or more implementations, process 300 may further include that when a recommended action generated by the system is implemented in the real-world environment, the resulting performance data—such as sensor readings, operational metrics, or system logs—is recorded and compared against the predicted effects previously generated by the counterfactual simulation. A discrepancy between predicted and observed outcomes may indicate incomplete priors, model drift, or previously unmodeled variables. The Bayesian inference engine may incorporate this discrepancy into subsequent updates, refining the observation model and state evolution model accordingly. Through repeated cycles of prediction, action execution, and model updating, the system enhances its accuracy over time and continuously improves its ability to propose high-performing policies in dynamic or uncertain environments.

In one or more implementations, the Bayesian inference algorithm corresponds to a stochastic variational inference algorithm that updates both observation priors and generative priors to account for new data. In some embodiments, the counterfactual policy can define constraints that enforce safety or operational constraints, thereby preventing exploration of actions beyond predefined risk thresholds. For example, the constraints can prevent developing scenarios which would violate an independent constraint, such as a health or safety constraint, a regulatory constraint, a budgetary constraint, a contract constraint, or the like.

The process 300 may also include that the domain comprises an industrial process, a supply chain, a medical application, or any system in which experimentation is costly or risky. The subject technology is well-suited to reinforcement learning without having to undergo costly or risky experimentation.

The process 300 can also include integrating knowledge from multiple large language models or multiple domain experts, thereby forming an ensemble of priors that the Bayesian inference algorithm weighs according to consistency with real-world data. For example, the Bayesian inference algorithm can assign a weight to each of the priors and combine such priors according to the assigned weight.

Although FIG. 3 shows example blocks of process 300, in some implementations, process 300 may include additional blocks, fewer blocks, different blocks, or differently arranged blocks than those depicted in FIG. 3. Additionally, or alternatively, two or more of the blocks of process 300 may be performed in parallel. Such data can be collected or received as described herein.

While process 300 focuses on a dynamic training and reinforcement system for a predictive engine, it is understood other functions or models can be developed using process 300 or similar methodologies without departing from the scope or spirit of the disclosure.

FIG. 4 illustrates a flowchart of an example process 400 disclosed herein for building, iterating, and updating a predictive model in an offline or online context. In some implementations, one or more process blocks of FIG. 4 may be performed by a device, such as one or more of the devices illustrated in connection with FIG. 2.

As shown in FIG. 4, at block 402, the system forms two foundational types of priors, including observation priors, which capture correlations and statistical relationships observed in real-world data (such as sensor streams or enterprise records), and generative priors, which describe how the domain is believed to evolve over time. These priors are created using a combination of domain-expert consultation (e.g., expert-provided causal factors, heuristics, or process rules) and large-language-model outputs (e.g., relationships surfaced by the LLM when prompted with domain-specific questions). This step directly ties back to the earlier discussion of factor-graph-based modeling, where priors initialize node potentials and factor dependencies in the world model. The priors serve as an informed, structured starting point for all later inference and simulation.

As shown in FIG. 4, at block 404, the system uses approximate Bayesian inference—for example, stochastic variational inference (SVI)—to combine the priors from block 402 with observational data and produce a state evolution model. This model represents how the “state of the world” changes in response to actions, resource changes, time progression, or external events. As discussed previously, this step (1) unifies expert knowledge, LLM-derived structure, and observed data; (2) fills in gaps where data is sparse; and (3) updates and calibrates factor-graph relationships. The resulting state evolution model becomes the computational core of the predictive engine that powers all downstream planning.

As shown in FIG. 4, at block 406, the system uses the predictive model to simulate many alternative futures, known in the specification as sample episodes or counterfactual scenarios. Each scenario examines “what would happen if we took Action X instead of Action Y?” These simulations are evaluated using the cost functions and constraints discussed earlier—constraints may reflect safety limits, resource caps, technical rules, or other guardrails. The system compares scenario outcomes to identify a best-performing policy that balances readiness, cost, throughput, safety, or other operational metrics. This step is the reinforcement-learning portion of the method, directly aligning with the earlier explanation of running large batches of “virtual experiments” safely in simulation to avoid costly or dangerous real-world trial-and-error.

As shown in FIG. 4, at block 408 the optimized policy identified in block 406 is implemented in the real operational environment—for example, executing a maintenance schedule, reallocating resources, or triggering logistical movements. The system then monitors the actual result, using the sensors and enterprise systems of record described earlier. This creates a real-world data point reflecting how the domain actually responded to the recommended course of action. As emphasized in earlier discussions, this observational step closes the loop between simulated, counterfactual planning and real-world outcomes.

As shown in FIG. 4, at block 410, the system retrieves the predicted effect previously generated for this action during simulation and compares it to the observed real-world effect collected at block 408. This comparison provides a formal predicted-vs.-observed discrepancy, which the system can analyze to determine whether the model was too optimistic, too conservative, or missing important information. This step reinforces the concept of auditability and traceability, which appears throughout the specification: every recommended action and its predicted effect is stored so the system can learn from deviations.

In one or more implementations, the system can use discrepancies to refine the priors or adjust internal parameters of the state evolution model. This refinement uses the same approximate Bayesian inference processes described earlier. This allows the predictive model to improve over time, learning from real world feedback and becoming increasingly accurate with each update cycle. As discussed earlier, this ensures the model avoids drift, continually aligns with the true domain dynamics, and supports safe, data efficient reinforcement learning.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. Such data can be collected or received as described herein.

While process 300 focuses on a dynamic training and reinforcement system for a predictive engine, it is understood other functions or models can be developed using process 300 or similar methodologies without departing from the scope or spirit of the disclosure.

FIGS. 5A and 5B are illustrate examples of a user interface in accordance with some embodiments.

FIG. 5A illustrates an example interface 505 for Lucky Logistics (a fictitious organization) that implements embodiments of the disclosure as discussed above. Interface 505 includes, to the left, a chat panel including an LLM-style input interface with a chat-type input with immediate feedback. This is where a user would talk to the system in natural language—report incidents (“Vehicle 3 broke an axle”), change constraints (“Cap this period's spend at $50k”), or explore scenarios (“What if we reassign Task 7 to Maintainer 1?”). After a user sends a message, the system parses the user intent and may provide a confirmation card (what it understood, e.g., the vehicle, issue, time). In some implementations, the user select to can apply, edit, or cancel the input prior to execution. The user can select (not shown) a more detailed view of the model logic. Inputs can explore “what if” questions and counterfactuals to test alternate courses of action, specify different factors or objectives (as above), identify problems or opportunities (e.g., what are the bottlenecks in achieving objective in 10 weeks, what have bottlenecks been historically, what resources if increased would have biggest impact on advancement toward objective, what is most improvement that can be made with $10k). Where an objective cannot be met, the output can articulate why it cannot be met and what could be changed to meet or exceed objective. An output can be provided with output updates to plans or policies to improve/optimize actions.

To the right of the interface 505, insight tabs can be selected to provide contextually relevant information which indicate greater detail than the chat window itself. Different tabs let the user switch between status and summary, plan, and model information. Status and summary provides a quick, visual pulse of the operation (past→current→projected). The user will see key performance indicators, such as ready now, target in 6 weeks, budget used, and risk, though other performance indicators can be provided. In some embodiments, a time-series chart of readiness with baseline vs. scenario lines. Further, an insights list calling out gaps and risks (e.g., “Shortfall of 4 vehicles by Mar 6”) may be provided, which can be selected to prompt the user to examine the underlying assumptions of such insights and explore predicted corrective measures (e.g., using various scenarios, such as discussed above) which can be used to address such insights. The planning tab includes the operational to-do list shaped by goals and constraints. The model parameters tab can include the assumptions, limits, and objective weights that drive the world model. Settings can be updated for handling the world model, such as specifying real-time updating or batch updating or a hybrid approach based on specific parameters.

As the user interacts with the interface 505, the interface can update so that the information provided on the right is updated based on the user input and instructions as well as contextually as the user input and the chat output implicates various logistical aspects of the system. Thus, when the user applies a change via chat, the model re-simulates and these panels refresh—so the user can see how a new constraint or fix changes the path to target.

FIG. 5B includes an illustration of an example interface 510 corresponding to the plan and actions tab of the interface 505. The plan and actions tab can be used to transform strategy into clear, accountable work and tasks that include an actions list that reads like a schedule. Each row is a task card: an ID and title (e.g., “231—Replace axle”), the owner (who's responsible), start/end dates, required parts, predecessors (work that must happen first), estimated cost, and risk level. A checkbox lets the user select items for batch actions.

A task can be opened, reassigned, or rescheduled from the list. If the scheduler suggests updates (for example, after change an objective is changed or someone goes on leave), the user can be prompted to Accept/Reject changes. A scrollable Gannt timeline can be used to show assigned tasks for a group or technician. Filters can be provided, for example, by owner, date window, status, risk, or resource to view or export the current plan for reporting or sharing.

The model parameters tab can include its own interface as well, that can display objectives and factor graphs and the like. For the predictive model as discussed herein. Constraints can be defined, such as real-world limits in budget caps, maintainer capacity, parts stock and lead times, approval rules, or policy boundaries (like allowed part substitutions). Assumptions can be specified, such as average repair durations, failure rates, labor costs, and MTBF. Scenario diffs can be provided. For example, a scenario can be compared to a baseline to determine exactly what changed (e.g., “Budget cap reduced from $80k→$50k; Maintainer 2 on leave 01/23-02/06”). Controls can be edited. For example, parameters can be edited and saved to a sandbox for a what-if scenario. Changes can be reverted or set to a baseline.

With respect to the illustrations of FIGS. 5A and 5B, each dialog-derived scenario can be assigned an internal identifier which can be used for tracing the output provided to the user. Projected outcomes and task lists may be retained, for example, in a database for later comparison to observed results and for auditing predictions to actual outcomes. The system can store its projected outcomes and associated task list (owner, schedule, dependencies, parts, risk). Upon execution, observed outcomes are linked to the identifier to support predicted-vs-observed comparison, audit, and Bayesian updating of factor potentials and edge weights.

FIG. 6 is a block diagram of a device system that may be used to implement at least a portion of aspects herein. FIG. 6 illustrates a device 600 which can embody or perform at least a portion of system 100, system 200, and/or process 300. Device 600 may comprise all or a part of modules or components herein. Device 600 may comprise hardware or a combination of hardware and software. The functionality to facilitate telecommunications via a telecommunications network may reside in one or combinations of links, portals, or connections. Device 600 depicted in FIG. 6 may represent or perform functionality of an appropriate device 600, or combination of modules or components herein. It is emphasized that the block diagram depicted in FIG. 6 is an example and not intended to imply a limitation to a specific implementation or configuration. Thus, device 600 may be implemented in a single device or multiple devices. Multiple network entities may be distributed or centrally located. Multiple network entities may communicate wirelessly, via hard wire, or any appropriate combination thereof.

Device 600 may comprise a processor 602 and a memory 604 coupled to processor 602. Memory 604 may contain executable instructions that, when executed by processor 602, cause processor 602 to effectuate operations associated with aspects disclosed herein. As evident from the description herein, device 600 is not to be construed as software per se.

In addition to processor 602 and memory 604, device 600 may include an input/output system 606. Processor 602, memory 604, and input/output system 606 may be coupled together to allow communications there between. Each portion of device 600 may comprise circuitry for performing functions associated with each respective portion. Thus, each portion may comprise hardware, or a combination of hardware and software. Accordingly, each portion of device 600 is not to be construed as software per se. Input/output system 606 may be capable of receiving or providing information from or to a communications device or other network entities configured for telecommunications. For example, input/output system 606 may include a wireless communications (e.g., WiFi/3G/4G/5G/GPS) card. Input/output system 606 may be capable of receiving or sending video information, audio information, control information, image information, data, or any combination thereof. Input/output system 606 may be capable of transferring information with device 600. In various configurations, input/output system 606 may receive or provide information via any appropriate means, such as, for example, optical means (e.g., infrared), electromagnetic means (e.g., RF, WiFi, Bluetooth®, ZigBee®), acoustic means (e.g., speaker, microphone, ultrasonic receiver, ultrasonic transmitter), or a combination thereof. In an example configuration, input/output system 606 may comprise a WiFi finder, a two-way GPS chipset or equivalent, or the like, or a combination thereof.

Input/output system 606 of device 600 also may contain communication connection 608 that allows device 600 to communicate with other devices, network entities, or the like. Communication connection 608 may comprise communication media. Communication media typically embody computer-readable instructions, data structures, program modules or other data in a modulated data signal such as a carrier wave or other transport mechanism and includes any information delivery media. By way of example, and not limitation, communication media may include wired media such as a wired network or direct-wired connection, or wireless media such as acoustic, RF, infrared, or other wireless media. The term computer-readable media as used herein includes both storage media and communication media. Input/output system 606 also may include an input device 610 such as keyboard, mouse, pen, voice input device, or touch input device. Input/output system 606 may also include an output device 612, such as a display, speakers, or a printer.

Processor 602 may be capable of performing functions associated with aspects described herein. For example, processor 602 may be capable of, in conjunction with any other portion of device 600, modeling or calculation described herein.

Memory 604 of device 600 may comprise a storage medium having a concrete, tangible, physical structure. As is known, a signal does not have a concrete, tangible, physical structure. Memory 604, as well as any computer-readable storage medium described herein, is not to be construed as a signal. Memory 604, as well as any computer-readable storage medium described herein, is not to be construed as a transient signal. Memory 604, as well as any computer-readable storage medium described herein, is not to be construed as a propagating signal. Memory 604, as well as any computer-readable storage medium described herein, is to be construed as an article of manufacture.

Memory 604 may store any information utilized in conjunction with telecommunications. Depending upon the exact configuration or type of processor, memory 604 may include a volatile storage 614 (such as some types of RAM), a nonvolatile storage 616 (such as ROM, flash memory), or a combination thereof. Memory 604 may include additional storage (e.g., a removable storage 618 or a nonremovable storage 620) including, for example, tape, flash memory, smart cards, CD-ROM, DVD, or other optical storage, magnetic cassettes, magnetic tape, magnetic disk storage or other magnetic storage devices, USB-compatible memory, or any other medium that can be used to store information and that can be accessed by device 600. Memory 604 may comprise executable instructions that, when executed by processor 602, cause processor 602 to effectuate operations for, e.g., modeling or calculation.

FIG. 6 and FIG. 7 depict an example hardware architecture for implementing the subject technology. A device (600) may comprise a processor (602), memory (604), and I/O system (606) interfaces. The server or set of servers (e.g., model server 106, analytics server 110) can be implemented in on-premises hardware or in a cloud infrastructure. The system stores priors, historical data, and sensor feeds in local or remote databases (e.g., 105). Because each portion of the system (e.g., the Bayesian inference module, reinforcement learning engine, sensor ingestion pipeline) can be deployed in a distributed architecture, the invention covers both single-machine and multi-machine embodiments. Network or message queues can connect sensors, enterprise record systems, and the model server, ensuring the approach scales to large enterprises or multi-site logistics networks.

FIG. 7 is a block diagram of a computer-based system that may be used to host the model server, analytics server, and other subsystems described. FIG. 7 illustrates a computer-based system 700 that may constitute or include parts of one or more of aspects of, e.g., FIGS. 1, 2, and/or 3, or device 600. Computer-based system 700 includes at least one processor, such as a processor 702. Processor 702 may be connected to a communication infrastructure 704, for example, a communications bus, a cross-over bar, a network, or the like. Various software aspects are described in terms of this example computer-based system 700. Upon perusal of the present description, it will become apparent to a person skilled in the relevant art(s) how to implement the present disclosure using other computer systems or architectures.

Computer-based system 700 includes a display interface 706 that forwards graphics, text, or other data from communication infrastructure 704 or from a frame buffer for display on a display unit 708.

Computer-based system 700 further includes a main memory 710, such as random access memory (RAM), and may also include a secondary memory 712. Secondary memory 712 may further include, for example, a hard disk drive 714 or a removable storage drive 716, representing a floppy disk drive, a magnetic tape drive, an optical disk drive, etc. Removable storage drive 716 reads from or writes to a removable storage unit 718 in a well-known manner. Removable storage unit 718 may represent a floppy disk, magnetic tape, or an optical disk, and may be read by and written to by removable storage drive 716. As will be appreciated, removable storage unit 718 includes a computer usable storage medium having computer software or data stored therein.

In accordance with various aspects of the present disclosure, secondary memory 712 may include other similar devices for allowing computer programs or other instructions to be loaded into computer-based system 700. Such devices may include, for example, a removable storage unit 720 and an interface 722. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from removable storage unit 720 to computer-based system 700.

Computer-based system 700 may further include communication interface 724. Communication interface 724 may allow software or data to be transferred between computer-based system 700 and external devices. Examples of communication interface 724 include, but may not be limited to a modem, a network interface (such as an Ethernet card), a communications port, a Personal Computer Memory Card International Association (PCMCIA) slot and card, or the like. Software or data transferred via communication interface 724 may be in the form of a number of signals, hereinafter referred to as signals 726, which may be electronic, electromagnetic, optical or other signals capable of being received by communication interface 724. Signals 726 may be provided to communication interface 724 via a communication path (e.g., channel) 728. Communication path 728 carries signals 726 and may be implemented using wire or cable, fiber optics, a telephone line, a cellular link, a radio frequency (RF) link, or other communication channels.

In this document, the terms “computer program medium” and “computer usable medium” are used to generally refer to media such as removable storage drive 716, a hard disk installed in hard disk drive 714, or the like. These computer program products provide software to computer-based system 700. The present disclosure is directed to such computer program products.

Computer programs (also referred to as computer control logic) may be stored in main memory 710 or secondary memory 712. The computer programs may also be received via communication interface 704. Such computer programs, when executed, enable computer-based system 700 to perform the functions consistent with the present disclosure, as discussed herein. In particular, the computer programs, when executed, enable processor 702 to perform the features of the present disclosure. Accordingly, such computer programs represent controllers of computer-based system 700.

In accordance with an aspect of the present disclosure, where the disclosure is implemented using a software, the software may be stored in a computer program product and loaded into computer-based system 700 using removable storage drive 716, hard disk drive 714, or communication interface 724. The control logic (software), when executed by processor 702, causes processor 702 to perform the functions of the present disclosure as described herein.

In another aspect, the present disclosure is implemented primarily in hardware using, for example, hardware components, such as application specific integrated circuits (ASIC). Implementation of the hardware state machine to perform the functions described herein will be apparent to persons skilled in the relevant art(s). In yet another aspect, the present disclosure is implemented using a combination of both the hardware and the software. In another aspect, the present disclosure is implemented using software.

While particular use cases are provided, various aspects disclosed herein are to be taken in the illustrative and explanatory sense, and should in no way be construed as limiting of the present disclosure. All numerical terms, such as, but not limited to, “first” and “second” or any other ordinary or numerical terms, should also be taken only as identifiers, to assist the reader's understanding of the various aspects, variations, components, or modifications of the present disclosure, and may not create any limitations, particularly as to the order, or preference, of any aspect, variation, component or modification relative to, or over, another aspect, variation, component or modification.

It is to be understood that individual features shown or described for one aspect may be combined with individual features shown or described for another aspect. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

The present disclosure is described herein with reference to system architecture, block diagrams, flowchart illustrations of methods, and computer program products according to various aspects of the disclosure. It will be understood that each functional block of the block diagrams and the flowchart illustrations, and combinations of functional blocks in the block diagrams and flowchart illustrations, respectively, can be implemented by computer program instructions.

Software elements disclosed or described herein may be loaded onto a general-purpose computer, special-purpose computer, or other programmable data processing apparatus to produce a machine, such that the instructions that execute on the computer or other programmable data-processing apparatus create means for implementing the functions specified in the flowchart block or blocks. These computer program instructions may also be stored in a computer-readable memory that can direct a computer or other programmable data-processing apparatus to function in a particular manner, such that the instructions stored in the computer-readable memory produce an article of manufacture including instruction means that implement the function specified in the flowchart block or blocks. The computer program instructions may also be loaded onto a computer or other programmable data-processing apparatus to cause a series of operational steps to be performed on the computer or other programmable apparatus to produce a computer-implemented process, such that the instructions that execute on the computer or other programmable apparatus provide steps for implementing the functions specified in the flowchart block or blocks. In an aspect, the computer program instructions may be executed on any remote-hosted application framework, for example, by a processor associated with a cloud server.

Accordingly, functional blocks of the block diagrams and flow diagram illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, web pages, websites, web forms, prompts, etc. Practitioners will appreciate that the illustrated steps described herein may comprise in any number of configurations including the use of windows, web pages, hypertexts, hyperlinks, web forms, popup windows, prompts, and the like. It should be further appreciated that the multiple steps as illustrated and described may be combined into single web pages and/or windows or may be expanded for the sake of simplicity. In other cases, steps illustrated and described as single process steps may be separated into multiple web pages and/or windows but may be combined for simplicity.

The systems, methods and computer program products disclosed in conjunction with various aspects of the present disclosure are embodied in systems and methods for facilitating multiple types of communications in systems and networks discussed herein.

Methodologies herein are described with specific aspects for ease of explanation with respect to various embodiments. However, methodologies embraced under the scope and spirit of the disclosure may vary, to include excluding particular aspects or comparisons described.

While aspects of the present disclosure have been particularly shown and described with reference to the examples above, it will be understood by those skilled in the art that various combinations of the disclosed aspects or additional aspects may be contemplated by the modification of the disclosed machines, systems and methods without departing from the spirit and scope of what is disclosed. Such aspects should be understood to fall within the scope of the present disclosure as determined based upon the claims and any equivalents thereof.

What is claimed is:

1. A method comprising:
generating a predictive model by applying a Bayesian inference algorithm to a set of observation priors and a set of generative priors, wherein at least a portion of the observation priors or the generative priors are generated at least in part from an output of a large language model;
generating a plurality of sample episodes using the predictive model, each sample episode representing a simulated trajectory of the real-world domain under a corresponding sequence of actions;
iteratively evaluating the plurality of sample episodes against a counterfactual policy, wherein the counterfactual policy is determined under one or more cost functions and constraints, and wherein the iterative evaluation results in an optimized prediction output corresponding to a first episode of the plurality of sample episodes;
storing a predicted effect corresponding to the first episode in a system of records;
causing information corresponding to the first episode to be provided to an implementation system, wherein the implementation system implements at least an aspect of the first episode;
receiving at least one of sensor inputs or an updated system record corresponding to the implementation of at least the aspect of the first episode;
comparing the predicted effect to the at least one of sensor inputs or updated system records to determine a discrepancy; and
updating the predictive model based on the Bayesian inference algorithm applied to at least one of sensor inputs or updated system records reflecting changes to a real-world domain corresponding to the predictive model and based on the discrepancy.

2. The method of claim 1, further comprising:
generating a factor graph domain model, wherein nodes of the factor graph domain model represent domain variables and wherein factors of the factor-graph domain model encode probabilistic relationships, the factor-graph domain model being parameterized by (i) the observation priors and (ii) the generative priors, wherein at least a portion of the observation priors are derived from domain-expert inputs, and wherein the Bayesian inference algorithm updates parameters of the factor graph domain model based on observational data.

3. The method of claim 2, wherein the predictive model comprises a state evolution model and an observation model corresponding to the factor graph domain model.

4. The method of claim 1, wherein the plurality of sample episodes are generated responsive to at least one of: a what-if scenario, a user-invoked optimization function, a user-defined objective, or one or more constraints.

5. The method of claim 1, further comprising:
applying a guardrail evaluation to at least one of (i) inputs provided to the large language model or (ii) outputs generated by the large language model before using the outputs to generate at least one of the observation priors, the generative priors, the one or more cost functions, or the one or more constraints, wherein the guardrails restrict output of the large language model to reduce hallucinations and to comply with a policy.

6. The method of claim 1, further comprising:
selecting an optimized policy based on the optimized prediction output, the optimized policy corresponding to the first episode of the plurality of sample episodes; and
producing, from the optimized policy:
(i) a projection of outcomes corresponding to the predicted effect, and
(ii) a task list comprising executable actions with at least one of: an owner, a scheduled time window, required parts, dependencies, or estimated risk.

7. The method of claim 6, further comprising:
storing the projection of outcomes and the task list in records in the system of records.

8. The method of claim 7, further comprising:
comparing the projection of outcomes to the changes to the real-world domain to compute the discrepancy.

9. The method of claim 1, wherein the updating is performed in one of an offline batch mode, an online real-time mode, or a hybrid mode that combines offline batch updates with online real-time updates.

10. The method of claim 1, further comprising:
utilizing the predictive model to determine one or more actions to improve at least one performance metric of the real-world domain, wherein the performance metric includes one or more of cost, efficiency, readiness, or safety.

11. The method of claim 1, wherein the Bayesian inference algorithm corresponds to a stochastic variational inference algorithm that updates at least one of the observation priors or the generative priors based on the changes to the real-world domain.

12. The method of claim 1, further comprising:
programming the counterfactual policy based on one or more cost functions and constraints generated at least in part from outputs of the large language model.

13. The method of claim 1, wherein the counterfactual policy enforces safety or operational constraints, thereby preventing exploration of actions beyond predefined risk thresholds.

14. The method of claim 1, further comprising:
implementing a hierarchical reinforcement learning approach wherein a high-level policy sets goals for one or more sub-policies, each sub-policy being updated in accordance with the predictive model.

15. The method of claim 1, further comprising:
assigning uncertainty weights to at least a portion of the set of observation priors or the set of generative priors; and
updating the uncertainty weights based on the sensor inputs or on the updated system record.

16. The method of claim 1, wherein the output of the large language model includes multiple large language models.

17. The method of claim 1, wherein at least a portion of the observation priors are derived from domain-expert inputs, the domain expert inputs comprising inputs from one or more domain experts, an ensemble of domain experts, or an agent of a large language model configured to mimic a domain expert.

18. The method of claim 1, wherein the optimized prediction output is selected from a group of prediction outputs corresponding to other sample episodes that are scored to exceed a threshold, or wherein the optimized prediction output is selected from a predetermined number of prediction outputs corresponding to the other sample episodes that are scored as the highest sample episodes of the plurality of sample episodes.

19. The method of claim 1, wherein iteratively evaluating the plurality of sample episodes comprises:
prior to simulating each timestep, computing an action mask that excludes actions outside a safe region defined by the one or more constraints; and
applying the action mask at a simulator kernel so that only masked-in actions are enumerated or sampled, thereby reducing successor-state expansion and processor cycles consumed during the evaluation.

20. The method of claim 1, wherein updating the predictive model comprises:
performing incremental stochastic variational inference that initializes variational parameters from a most-recent posterior associated with a prior model version and updates the parameters using minibatches of the received sensor inputs or updated system records, thereby avoiding retraining from scratch and reducing an amount of computation required to assimilate new evidence.

21. The method of claim 1, wherein the predictive model represents the factor-graph domain model in a sparse matrix format and evaluates factor messages in a topologically sorted order using vectorized or GPU-executed kernels, thereby reducing memory footprint and improving cache locality during counterfactual policy evaluation.

22. The method of claim 1, further comprising:
causing a user interface to be rendered on a display, the rendering including, via the user interface, a planner view listing executable actions for the optimized prediction output, each action presented as a task card comprising one or more of: a task identifier, an owner, start and end dates, predecessor tasks, required parts with lead times, estimated cost, or a risk level, wherein responsive to the optimized prediction output, a machine-executable task listed is generating from the planner view formatted for the implementation system.

23. The method of claim 22, further comprising:
causing a scenario-difference panel to be displayed in the user interface that enumerates parameter deltas relative to a baseline including at least a change in a displayed element corresponding to a model parameter; and
responsive to a change to at least one model parameter received via the user interface, causing an automatic re-rendering of the plurality of sample episodes and refreshing one or more of a status view, the planner view, or a model-parameters tab to display values associated with an updated optimized prediction output.

24. The method of claim 22, further comprising:
causing the user interface to display, for the optimized prediction output, a sample episode ID and model version within the user interface to provide provenance to a stored prediction-effect record in the system of records.

25. A device comprising:
a processor; and
memory, wherein the processor is configured to perform operations comprising:
generating a set of observation priors and a set of generative priors using at least one of: (i) prompts to a large language model, (ii) input from at least one domain expert, or (iii) observational data from one or more sensors or enterprise systems of record;
constructing, for a target domain, a factor-graph domain model whose nodes represent domain variables and whose factors encode probabilistic relationships, the factor-graph domain model being parameterized by the observation priors and the generative priors;
constructing a state evolution model using approximate Bayesian inference to unify the observation priors and the generative priors with observational data for the target domain;
producing an optimized action policy by simulating multiple counterfactual scenarios in accordance with a cost function and one or more constraints;
executing one or more steps of the action policy in a physical environment, measuring a real-world result, and comparing the real-world result to a predicted effect stored in a system of records; and
adjusting at least one prior or parameter in the state evolution model based on a discrepancy between the real-world result and the predicted effect.

26. The device of claim 25, wherein the processor is further configured to perform operations comprising:
repeatedly or continuously updating the factor-graph domain model in real-time based on streamed sensor data;
restricting proposed actions to a safe region via constraint enforcement; and
operating in at least one of (i) an offline mode, (ii) an online mode, or (iii) a hybrid mode in which a first data source is updated in batch and a second data source is updated in real time.

27. The device of claim 26, wherein operating is performed in the offline mode when real-time feedback is unavailable or impractical.

28. The device of claim 25, wherein the processor is further configured to perform operations comprising:
assigning uncertainty weights to at least a portion of the set of observation priors or the set of generative priors; and
updating the uncertainty weights based on the streamed sensor data.

29. The device of claim 25, wherein the constraints comprise: guardrails, regulatory limits, technical manual rules, budget caps, resource capacities, or policy boundaries, enforced by at least one of action masking, barrier penalties, or Lagrangian relaxation.

30. The device of claim 25, wherein the processor is further configured to perform operations comprising:
providing a user interface to a user device, thereby causing the user interface to be displayed at the user device, the user interface including a dialog displaying a planner view associated with the action policy corresponding to a task list for the action policy, wherein the planner view includes task identifiers, owners, start and end dates, predecessor tasks, required parts with lead times, and risk levels, and wherein user approval of edits to the task list triggers a refresh of the user interface.

31. The device of claim 25, wherein the processor is further configured to perform operations comprising:
updating the factor-graph domain model to add or remove nodes or factors in response to evidence of previously unmodeled variables detected from observed outcomes.

32. A non-transitory computer-readable medium storing instructions thereon, which when executed by one or more processors cause the one or more processors to perform operations comprising:
generating a predictive model by applying a Bayesian inference algorithm to a set of observation priors and a set of generative priors, wherein at least a portion of the observation priors or the generative priors are generated at least in part from an output of a large language model;
generating a plurality of sample episodes using the predictive model, each sample episode representing a simulated trajectory of the real-world domain under a corresponding sequence of actions, responsive to at least one of: a what-if scenario, a user-defined objective, or one or more constraints;
iteratively evaluating the plurality of sample episodes against a counterfactual policy, wherein the counterfactual policy is determined under one or more cost functions and constraints, and wherein the iterative evaluation results in an optimized prediction output corresponding to a first episode of the plurality of sample episodes;
storing a predicted effect corresponding to the first episode in a system of records;
causing information corresponding to the first episode to be provided to an implementation system, wherein the implementation system implements at least an aspect of the first episode;
receiving at least one of sensor inputs or an updated system record corresponding to the implementation of at least the aspect of the first episode;
comparing the predicted effect to the at least one of sensor inputs or updated system records to determine a discrepancy; and
updating the predictive model based on the Bayesian inference algorithm applied to at least one of sensor inputs or updated system records reflecting changes to a real-world domain corresponding to the predictive model and based on the discrepancy.

33. The non-transitory computer-readable medium of claim 32, wherein the operations further comprise:
generating a factor graph domain model, wherein nodes of the factor graph domain model represent domain variables and wherein factors of the factor-graph domain model encode probabilistic relationships, the factor-graph domain model being parameterized by (i) the observation priors and (ii) the generative priors, wherein at least a portion of the observation priors are derived from domain-expert inputs, and wherein the Bayesian inference algorithm updates parameters of the factor graph domain model based on observational data.
